(19) United States
(12) Patent Application Publication
(10) Pub. No.: US 2004/0186766 A1
(43) Pub. Date: Sep. 23, 2004

(54) Apparatus and method for marketing to instant messaging service users

(75) Inventors: Craig William Fellenstein, Brookfield, CT (US); Carl Phillip Gusler, Austin, TX (US); Rick Allen Hamilton II, Charlottesville, VA (US); James Wesley Seaman, Falls Church, VA (US)

Correspondence Address: Rudolf O. Siegesmund, Suite 2000, 4627 N. Central Expressway, Dallas, TX, 75205-4017, US

(73) Assignee: International Business Machines Corporation, Armonk, NY

(21) Appl. No.: 10/392,789

(22) Filed: Mar. 19, 2003

(51) Int. Cl. G06F 17/60

(52) U.S. Cl. 705/14

(57) ABSTRACT

A method and apparatus for marketing advertisements to instant messaging users. The invention comprises: a user registration program, a user selection program, an advertisement delivery program, a queuing program, and an instant messaging interface program. The instant messaging interface program interfaces between an instant messaging service and the present invention. The user registration program allows the user to register with an instant messaging service and indicate the types of goods and/or service he is interested in. The user selection program selects users form the instant messaging service's database based on advertiser established criteria. The advertisement delivery program delivers the advertisement in a format that does not disrupt their online chats by notifying the user that the advertisement is ready for viewing. Users have the option of viewing, saving, or deleing the advertisement. Users may also view additional information, view coupons, play a game, or temporarily block the delivery of advertisements.

### FIELD OF THE INVENTION

The present invention relates to a method for advertising goods and services to users of instant messaging services. Specifically, the present invention is directed to a software program that collects user interest information about goods and services and informs the users of available goods and services through advertisements via an instant messaging service.

### BACKGROUND OF THE INVENTION

The growth of the Internet has resulted in the creation of new and varied methods of electronic communication between people. One of these communication methods is instant messaging. Instant messaging refers to a software application that allows users to communicate with one another in real time, without the delay involved in email. Instant messaging users may set up chat rooms where users with similar interests can come together to discuss or “chat” about common interests. Instant messaging users may also set up private rooms so that only authorized users can view the instant messages. Moreover, instant messaging is not limited to computer applications. Instant messaging services are available for personal digital assistants (PDA), cellular telephones, and similar digital and analog devices.

In a typical instant messaging application, a user registers with an instant messaging service, provides payment information, and creates a user name. The user name is not limited to permutations of the user's first, middle, and last name. Users typically create a user name that communicates an interest in a particular hobby, sports team, geographical location, or similar interest. Common examples of online messaging service user names include: Camaro_fan, Sooner_fan, Cowgirl, Rangers_No_{—}1, and the like. Other users can view a list of users in a particular chat room and discern the interests of the users based on their user name.

Advertisers are always seeking out new and more effective methods of promoting products and services to consumers. As such, any improvements in methods of identifying an interested consumer base are valuable to advertisers. Some advertisers have attempted to advertise to interested consumers via mass email or regular mail. Unfortunately, mass email or regular mail advertising mechanisms are not efficient because such mechanisms reach dozens if not hundreds of uninterested consumers for every interested consumer that is reached. Likewise, advertising through banner advertisements on web pages is also inefficient because the banner advertisements are displayed to every person who views the web page and not just to interested consumers. Pop-up advertisements are inefficient as well and are considered a nuisance by many people who use the Internet. Therefore, a more focused method of advertising goods and/or services is needed.

The concept of focused marketing over the Internet has been frequently addressed in the prior art. For example, U.S. Pat. No. 6,330,554 B1 (the '554 patent) entitled “Methods and Apparatus Using Task Models for Targeting Marketing Information to Computer Users Based on a Task Being Performed” discloses a marketing tool that advertises goods and/or services that are complementary to the goods and/or services offered on a webpage. The '554 patent reasons that a person who views a webpage is interested in the subject matter of the webpage, and therefore would be interested in complementary products as well. U.S. Pat. No. 6,338,044 B1 (the '044 patent) entitled “Personal Digital Content System” discloses an advertising method that focuses advertising on consumers based upon the consumers' demographics. U.S. Pat. No. 6,205,432 B1 (the '432 patent) entitled “Background Advertising System” discloses an advertising method that places advertisements in the background of an email, website, or similar communication message. The '432 patent creates background advertisements that are less intrusive than traditional advertisements. United States Patent Application Publication 2001/0047294 A1 (the '294 publication) entitled “System and Method for Adding an Advertisement to a Personal Communication” discloses a method for adding advertisements to the end of email messages. The '294 publication allows email composers to profit from the advertisements they attach to their emails. What is needed beyond the '554 patent, the '044 patent, the '432 patent, and the '294 publication is a marketing tool for electronically networked communications that actively seeks out consumers with specific interests and who would be interested in receiving information about a specific line of products associated with those interests. In addition, a need exists for a marketing tool that can also take advantage of instant messaging services.

U.S. Pat. No. 6,301,609 B1 (the '609 patent) entitled “Assignable Associate Priorities for User-Definable Instant Messaging Buddy Groups” discloses a modification of the conventional instant messaging system. The '609 patent allows instant messaging users to define rules for receiving and responding to instant messaging communications. However, the '609 patent is limited in that it does not disclose a method for marketing to instant messaging users. United States Patent Application Publication 2002/0184089 A1 (the '089 publication) entitled “Methods, Devices, and Systems for Real-Time Instant Presence with Advertisement (RIPA)” discloses an advertisement system applicable to instant messaging services. The '089 publication discloses a method of communicating advertisements to specific instant messaging users (i.e. people on the user's “buddy list”). However, the '089 publication is limited in that it does not disclose a method of advertising to instant messaging users outside the user's “buddy list”. Direct marketing to Instant Messaging IDs, especially when combined with nascent interactive agents, has not been addressed by the prior art. Therefore, what is needed beyond the '609 patent and the '089 publication is a marketing tool that actively seeks out a wide range of consumers who use instant messaging services, who have specific interests, and who would be interested in receiving information regarding a specific line of products associated with those interests via their instant messaging service.

Consequently, what is needed in the art is an advertising method and apparatus that is able to identify a consumer base of instant messaging service users where each of the identified instant messaging service users has an interest in a particular type of good and/or service and wants to receive information regarding the particular type of good and/or service. Moreover, the need extends to an advertising method that allows an advertiser to create selection criteria and focus advertisements on consumers based on specific consumer attributes. Finally, the need extends to an advertising system that can market goods and services to instant messaging users.

### SUMMARY OF THE INVENTION

The present invention, which meets the needs identified above, is a method and apparatus for marketing advertisements to instant messaging users. The invention can be embodied in software operable on a computer. In the software embodiment, the invention comprises: a user registration program, a user selection program, an advertisement delivery program, a queuing program, and an instant messaging interface program. The instant messaging interface program interfaces between an instant messaging service and the present invention. The user registration program allows the user to register with an instant messaging service and indicate the types of goods and/or service he is interested in. The user selection program selects users from the instant messaging service's database based on criteria established by the advertiser. Advertiser selection criteria include the user profile, the user name, the user's interests, and random generation.

The advertisement delivery program delivers the advertisement to the targeted user in a format that does not disrupt the user's online chats or other communications. Using the queuing program, the advertisement delivery program queues the advertisements for the user at regular intervals and passively notifies the user that the advertisement is ready for viewing. The user has the option of temporarily blocking the delivery of advertisements. Users have the option of viewing, saving, or deleting the advertisement. If the user views the advertisement, the user has additional options of viewing additional information, viewing a coupon, playing an interactive game, or unsubscribing from the subscription service. The advertisement delivery program continues to queue advertisements until the user logs off. Numerous alternative embodiments are also disclosed including applications for wireless communications.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is a depiction of the organization of the Instant Messaging Marketing Program (IMMP);

FIG. 3 is a flowchart of the logic of the Instant Messaging Interface Program (IMIP);

FIG. 4 is a flowchart of the logic of the User Registration Program (URP);

FIG. 5 is a flowchart of the logic of the User Selection Program (USP);

FIG. 6 is a flowchart of the logic of the Queuing Program (QP);

FIG. 7 is a flowchart of the logic of the Advertisement Delivery Program (ADP); and

FIG. 8 is an illustration of the IMMP installed on a computer readable memory.

### DETAILED DESCRIPTION OF THE PREFERRED EMBODIMENT

As used herein, the term “instant messaging service” refers to a person, group of people, company, or other organization that provides an electronic communication pathway between a plurality of people including without limitation personal chat applications. As used herein the term “electronic communication pathway” means either a wired or wireless connection between a plurality of computers via a network such as the Internet. As used herein, the term “user” means a person that uses an instant messaging service. As used herein, the term “user name” means a word or term that differentiates one user from a plurality of other users and shall have the same meaning as the term “Instant Messaging ID”). As used herein, the term “advertiser” means a person, group of people, company, or other organization that communicates the existence of goods or services to others. The term “computer” as used herein means a device comprising at least a memory and a data processor which is used to process information from a source and delivers the information to another source and that has the necessary hardware and software to network with other computers via a wired or wireless connection. As used herein, the term “interactive software agent” means a program that performs a repetitive task to gather or display information using the Internet and shall have the same meaning as the terms “bots”, “Internet bots”, and “interactive bots”. Examples of information transmitted through interactive bots are queries to the user for “yes” or “no” responses, opportunities for the user to request additional information through commands such as “tell me more,” “send more information,” or “provide more detail,” and transmission of incentives within the interactive bot. One example of an incentive contained within an interactive bot is an instantly redeemable electronic “coupon.” Another example of an incentive contained within an interactive bot is a gaming devices designed to attract the user into more detailed interaction. Such a gaming device could offer trivia quizzes or other such entertainment through the instant messaging system whereby the user receives discounts or improved services based upon the user's performance in the gaming device. Alternatively, the interactive bot can include a link that the user could click in order to respond to an offer, open a web page or simply receive additional explanatory promotional text. Persons skilled in the art are aware of a wide array of options available in designing interactive bots.

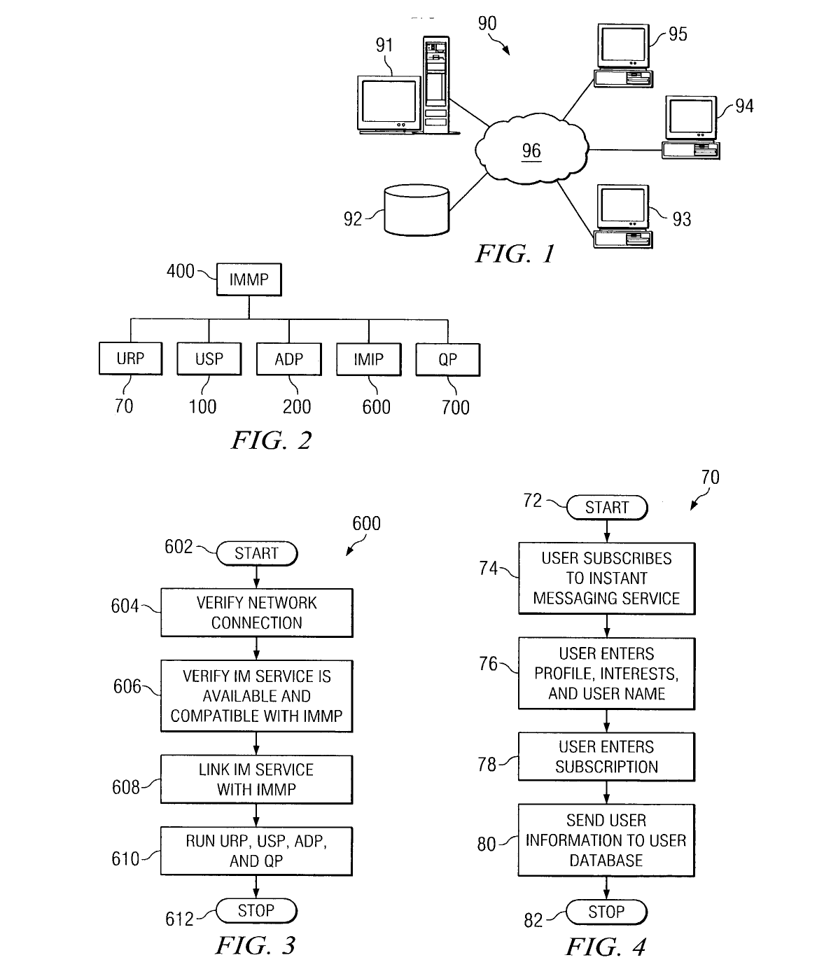

The present invention is a methodology that can be embodied in a computer program. FIG. 1 is an illustration of a computer network 90 associated with the software embodiment of the present invention. The computer network 90 comprises a local machine 95 electrically coupled to a network 96. Local machine 95 is electrically coupled to remote machine 94 and remote machine 93 via network 96. Local machine 95 is also electrically coupled to a server 91 and a database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of all possible operating systems that may contain the present invention and is not meant as an architectural limitation. Computer network 90 described herein can be the computer network of an instant messaging service. Alternatively, server 91 can represent the instant messaging service computer network and remote machines 93, 94, and local machine 95 representing the users' computers.

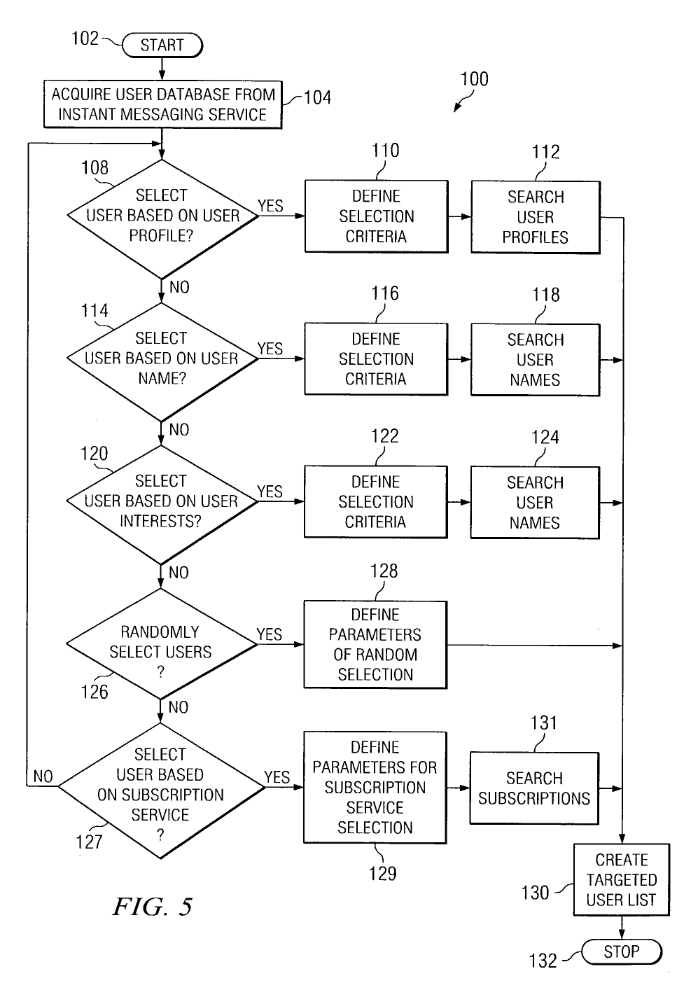

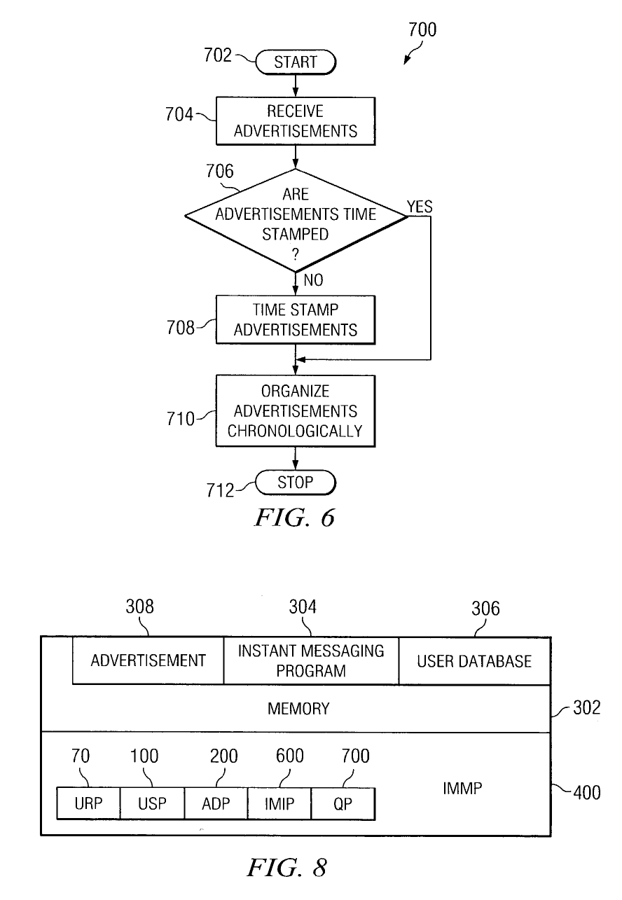

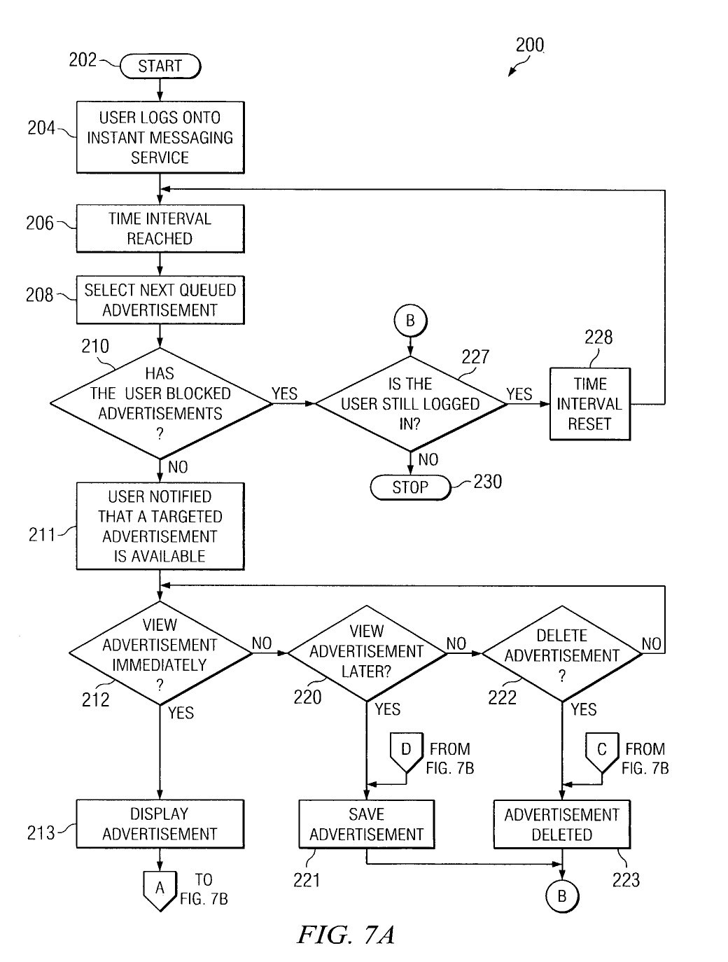

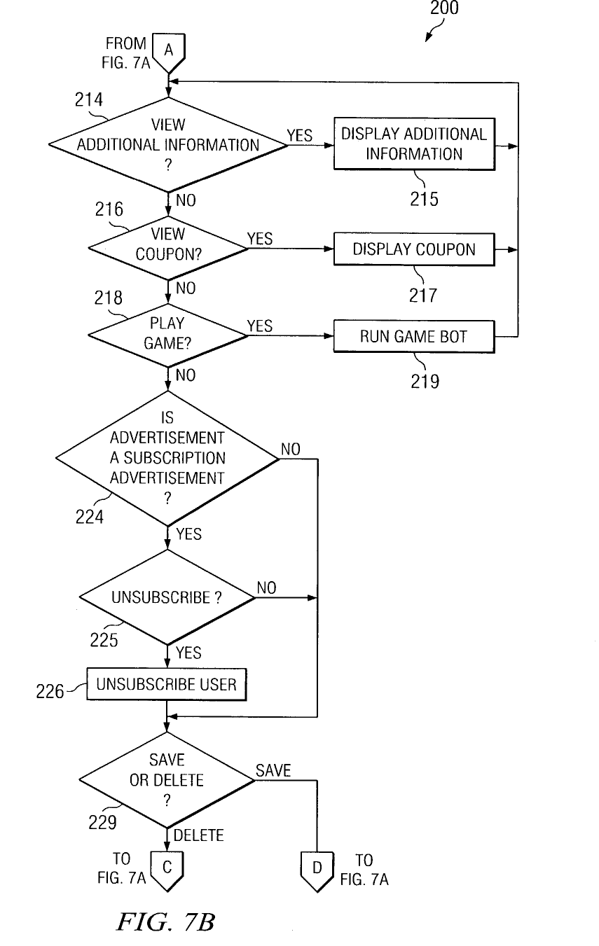

Referring to FIG. 2, the methodology of the present invention is implemented on software by Instant Messaging Marketing Program (IMMP) 400. IMMP 400 comprises Instant Messaging Interface Program (IMIP) 600 (See FIG. 3), User Registration Program (URP) 70 (see FIG. 4), User Selection Program (USP) 100 (see FIG. 5), Queuing Program (QP) 700 (see FIG. 6), and Advertisement Delivery Program (ADP) 200 (see FIG. 7). URP 70 and ADP 200 provide for user interaction with a program stored in the instant messaging service's computer (see FIG. 8). The preferred method for communicating between the user and the instant messaging service is through a computer via the Internet. However, various other types of information delivery are known by those skilled in the art. Moreover, USP 100 provides for advertiser interaction with a program stored in the instant messaging service's computer (see FIG. 8).

Referring to FIG. 3, IMIP 600 is shown. IMIP 600 connects the instant messaging service operating program with the programs of the present invention. IMIP 600 starts (602) and verifies that a network connection is present (604). In verifying that a network connection is present, IMIP 600 verifies that the computer containing the instant messaging service program is connected to at least one user computer. IMIP 600 also verifies that the operating program of the instant messaging service is available and is compatible with IMMP 400 (606). IMIP then links the instant messaging service program with IMMP 400. IMIP 600 then runs the URP 70, USP 100, ADP 200, and QP 700 as required. IMIP 600 then ends (612).

Referring to FIG. 4, URP 70 is an improved method for a user to register with an instant messaging service. URP 70 starts (72) when the user subscribes to an instant messaging service (74). The prior art method of user registration with an instant messaging service involves input of information such as the user's real name, a user name, an email address, and payment information on a form on a webpage. In URP 70, the user is then prompted to enter a user profile, and user interests, in addition to a user name (76). The user name can be the user's first and last name, but more commonly reflects the user's interests. The user profile includes information about the user such as age, sex, marital status, age and number of children, whether the user owns or rents a home, and so forth. User interests and hobbies may be presented in the form of a list that the user can browse and make selections from the list. Alternatively, the user can enter specific terms that indicate what types of goods and services he or she is interested in. The user may also indicate that he or she desires to receive custom promotional offers that are specifically targeted to his or her interests by selecting a subscription service option (78). For example, when a user registers as a member of a given Internet chat service, the user is asked by URP 70 whether the user would like to receive advertising regarding a specific subject such as vacation trips to Las Vegas. The subscription service is an opportunity for the users to identify a specific area of interest and designate the parameters of the advertisements they receive. The URP 70 then stores the user information in the user database (see FIG. 8) and stops (82).

Referring to FIG. 5, USP 100 is a method for an advertiser to target instant messaging users registered in an instant messaging user database. The user database is the entire list of instant messaging users associated with a particular instant messaging service. USP 100 starts (102) and acquires the user database from the instant messaging service (104). The advertiser then defines the user selection criteria. The user selection criteria are used to identify a particular group of users and to segment that group of users from the entire list of users in the user database. The advertiser can select the users based on the following criteria: user profile, user name, user interests, random selection, or subscription service.

The user profile is the physical information associated with a user. If the advertiser chooses to select users based on the user profile (108), USP 100 prompts the advertiser to define the selection criteria (110). The advertiser then enters the profile types for which the advertiser is searching and USP 100 searches the user database for those user profiles (112). For example, an advertiser may desire to advertise a mortgage rate special available to first time home buyers in Texas. The advertiser would define the search criteria as renters who live in Texas. USP 100 would then identify all of the renters living in Texas and create a list of targeted users (130). USP 100 then ends (132).

The user name is the screen name the user uses on his or her instant messaging service. If the advertiser chooses to select users based on the user name (114), USP 100 prompts the advertiser to define the selection criteria (116). The advertiser then enters a list of specific words or terms and USP 100 searches the user database for user names containing those specific words or terms (118). For example, an advertiser may desire to communicate the fact that a business specializes in replacement and upgrade parts for vintage Chevrolet® “muscle” cars. The advertiser would then define the selection criteria as user names which include at least one of the following terms: Chevrolet®, Camaro®, Nova®, Impala®, Malibu®, the years 1965-1972 (also '65-'72), and so forth. USP 100 would then identify all of the users who have user names in the user database that contain those search words or terms and create a list of targeted users (130). USP 100 then ends (132).

The user interests are interests and hobbies that the individual users indicate in URP 70. If the advertiser chooses to select users based on the user interests (120), USP 100 prompts the advertiser to define the selection criteria (122). The advertiser then enters the specific interests or hobbies for which the advertiser is searching and USP 100 searches the user database for those user interests and hobbies (124). For example, an advertiser may desire to communicate a special sale that a backpacking store is running. In that case, the advertiser could define the selection criteria as backpacking, hiking, camping, outdoor events, or some other appropriate criteria. USP 100 then identifies all of the users in the user database that have indicated the requisite interests. USP 100 then creates a list of targeted users (130) and ends (132).

A random search is one that does not use any selection criteria. If the advertiser chooses to select users randomly (126), USP 100 prompts the advertiser to define the parameters of the random selection (128). For example, if a user database is comprised of 100,000 users and the advertiser desires to send out 1,000 advertisements, then the advertiser can designate the selection parameters as one percent of the entire user database. Alternatively, the advertiser could select 1,000 random users. USP 100 then creates a target user list by selecting the appropriate number or percentage of the users at random (130) and USP 100 ends (132).

A subscription service selection provides advertising to users who have indicated a desire to receive advertising from specific market segments when they registered using URP 70. If the advertiser chooses subscription service selection (127), then the advertiser defines the search parameters for the subscription service (129). USP 100 then searches the subscribed users for the search parameters (131). For example, if an advertiser was advertising Las Vegas vacation packages, then the advertiser would enter search terms such as vacation and Las Vegas. USP 100 then identifies all of the users in the user database who have subscribed for advertisements on a particular subject. USP 100 then creates a list of the targeted users (130) and ends (132).

FIG. 6 depicts a flowchart for Queuing Program (QP) 700. QP 700 queues advertisements for delivery to the user. Queuing advertisements means that the advertisements are lined up in an orderly fashion. It is possible for multiple advertisements to be lined up in the queue. QP 700 (702) starts and receives the advertisements from the advertiser, if any, along with the advertisements saved in step 221 of ADP 200 (704). QP 700 then makes a determination if the advertisement is time stamped 706. Time stamping is a process known to persons skilled in the art whereby the time at which an advertisement was created is electronically encoded within the advertisement. If the advertisement is time stamped, QP 700 proceeds to step 710. If the advertisement is not time stamped, QP 700 time stamps the advertisement with the current time (708) and proceeds to step 710. At step 710, QP 700 organizes the advertisements chronologically (710). Chronological organization allows the oldest advertisements to be placed at the front of the queue. Persons skilled in the art are aware of other methods for organizing advertisements including in order of importance and reverse chronology. QP 700 then ends (712).

Referring to FIG. 7, ADP 200 is one possible methodology for sending advertisements to the targeted users. ADP 200 interacts with an advertisement created by an advertiser. Methods for creation of an advertisement are well known in the art. Similarly, methods for electronic delivery of an advertisement are also well known in the art. Preferably, the advertisement is stored in the memory of the instant messaging service's computer (see FIG. 8). Alternatively, the advertisement can be stored at another location and ADP 200 can access the advertisement and deliver the advertisement to the consumer. Persons skilled in the art are aware of methods for accessing and delivering an advertisement stored in either a local memory or a memory at an outside location.

ADP 200 begins (202) when a targeted user logs onto the instant messaging service (204). When the user logs onto the instant messaging service, a time interval clock is started such that the user will receive an advertisement on regular intervals (for example, every ten minutes) until all of the advertisements for that user are delivered. The specific time interval can be set by the user, the advertiser, or by the instant messaging service. When the time interval is reached (206), the next queued advertisement is selected for delivery to the user using QP 700 (208). However, queued advertisements are not necessarily immediately delivered. The user may desire to temporarily block advertisements, i.e. when he or she is engaged in an instant messaging conversation with another user. The user may engage or disengage the advertisement blocker at any time. ADP 200 checks to see if the user has blocked advertisements (210). If the user has blocked advertisements, then ADP 200 proceeds to step 227. If the user has not blocked advertisements, then the user is notified that a target advertisement is available for viewing (211). The user notification in step 211 is preferably accomplished by a non-invasive method such as lighting up or blinking a light on the user's instant messaging screen. Alternatively, the user can receive an instant message indicating that an advertisement is available. Another alternative is that the notification could be provided by an interactive bot in the form of a brief text message such as “promotion offer queued, receive now: Yes/No.”, to which the user could respond. Yet another alternative is that the user could be sent an instant message or a pop-up screen to appear on the user's instant messaging screen. Further in the alternative, the advertisement can be emailed to the user.

When the user is notified that a targeted advertisement is available in step 211, the user has at least three options on how to treat the advertisement. The user can choose to view the advertisement immediately (212). If the user chooses option 212, then the advertisement is displayed on the user's instant messaging screen (213). The user then has the option of viewing additional information regarding the advertisement (214). One example of additional information is the terms and conditions associated with an offer or advertisement. Other forms of additional information pertinent to the advertisement are known by persons skilled in the art. If the user chooses to view more information regarding the advertisement, then ADP 200 displays the additional information and proceeds to step 214. Another option after step 213 the user is presented with is to view a coupon (216). A coupon is a discount on goods or services that can be redeemed online or printed and redeemed in person. If the user decides to view a coupon, then ADP 200 displays the coupon (217) and returns to step 214. Another option that the user is presented with after step 211 is to play a game (218). If the user decides to play a game, then ADP 200 runs a game bot and returns to step 214. A game bot is an interactive online game in which the user receives an incentive for playing the game. Various different game bots are known to persons skilled in the art. If the user does not select options 214, 216, or 218, then ADP 200 proceeds to step 224.

ADP 200 then makes a determination if the advertisement is a subscription advertisement (224). If the advertisement is not a subscription advertisement, then ADP 200 proceeds to step 229. If the advertisement is a subscription advertisement, then ADP 200 queries the user as to whether the user wants to unsubscribe from the present subscription (225). If the user does not want to subscribe, then ADP 200 proceeds to step 229. If the user does want to unsubscribe, then ADP 200 deletes the user's subscription (226) and proceeds to step 229. At step 229, the user is presented with an option of saving or deleting the advertisement. If the user chooses to save the advertisement, then ADP 200 proceeds to step 221. If the user chooses to delete the advertisement, then ADP 200 proceeds to step 223.

After step 211, the user also has the option to view the advertisement later (220). If the user chooses option 220, then the advertisement is saved for later viewing (221) and ADP 200 goes to step 227. Optionally after step 221, ADP 200 can reset the time stamp on the advertisement such that QP 700 queues the advertisement at the end of the queue. After step 211, the user can also choose to delete the advertisement (222). If the user chooses option 222, then the advertisement is deleted (223) and ADP 200 proceeds to step 227. Other options at step 211 include: providing a small display screen adjacent to the user's instant messaging screen to allow the user to simultaneously view both instant messages and the advertisement, and allowing the user to connect to a web page via a hyperlink. In an alternate embodiment, the advertisement is sent and displayed at a set interval without providing the user with prior notification. Other options at step 211 are known to persons skilled in the art.

At step 227, ADP 200 determines if the user remains logged on to the instant messaging service (227). If the user remains logged on to the instant messaging service, the time interval for queuing advertisements is reset (228) and ADP 200 returns to step 208. If at step 227 the user is not logged on anymore, then ADP 200 ends (230).

The internal configuration of a computer, including connection and orientation of the processor, memory and input/output devices, is well known in the art. URP 70, USP 100, ADP 200, IMIP 600, and QP 700 described herein can be stored within the memory of a computer on the instant messaging service's computer network. Alternatively, URP 70, USP 100, ADP 200, IMIP 600, and QP 700 can be stored in an external storage device such as a removable disk or a CD-ROM. Turning to FIG. 8, memory 302 is illustrative of the memory within the instant messaging service's computer. The memory 302 contains the instant messaging program 304, the user database 306, and the advertiser's advertisement 308. As part of the present invention, the memory 302 can be configured with IMMP 400 comprising URP 70, USP 100, ADP 200, IMIP 600 and/or QP 700.

In alternative embodiments, IMMP 400, URP 70, ADP 200, IMIP 600, and QP 700 can be stored in the memory on the user's computer. Similarly, URP 100 can be stored on the memory in the advertiser's computer. This configuration allows the processor workload to be distributed across three processors instead of a single processor. Further configurations of IMMP 400, URP 70, USP 100, ADP 200, IMIP 600, and QP 700 across various memories are known by persons skilled in the art.

Numerous alternatives of the present invention are apparent to persons skilled in the art. Primarily, the present invention is applicable to instant messaging services on cellular telephones, personal digital assistants (PDAs), and other wireless devices. In the wireless embodiment, the graphical user interface of the wireless device is used in place of the graphical user interface of the computer.

In an additional embodiment, ADP 200 of the present invention can be configured to deliver advertisements at random intervals instead of pre-defined regular intervals. Alternatively, the targeted advertisements can be queued whenever the targeted user logs on, eliminating any delay between identification of the targeted user and user notification of the existence of a targeted advertisement.

Furthermore, while the present invention is disclosed in conjunction with targeted advertisements, the present invention includes all types of communication and promotional offers. For example, either online or printed coupons could be targeted at the user. Additionally, the advertisement can be configured with a game or similar feature to draw the user's interest into the advertisement. Advertisements can also be configured with hyperlinks to additional information or to a website.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method for creating a targeted list of users from a user database based on selection criteria, said user being instant messaging users and having a specific user name and user definable interests, said method comprising:
connecting a user computer to a network;
using the user computer, accessing an instant messaging marketing program that interfaces with an instant messaging program located on the network;
using the instant messaging marketing program to perform the steps of:
acquiring a user database;
defining a selection criterion, said selection criterion being defined by an advertiser;
searching said user database using said selection criterion; and
creating a list of targeted users based on said search.

2. The method of claim 1, wherein said selection criterion is a specific user profile.

3. The method of claim 1, wherein said selection criterion is a specific word or term in a user name.

4. The method of claim 1, wherein said selection criterion is a specific user interest identified by the user.

5. The method of claim 1, wherein said selection criterion is random selection of users.

6. A method comprising:
connecting a user computer to a network;
using the user computer, accessing an instant messaging marketing program that interfaces with an instant messaging program located on the network;
using the instant messaging marketing program to perform the steps of:
queuing a plurality of advertisements.

7. The method of claim 6 further comprising:
determining if a user has blocked said advertisement; and
responsive to a determination that said user has not blocked said advertisement, notifying a user that said advertisement is available.

8. The method of claim 6 further comprising:
selecting a time interval;
starting a clock;
wherein said queuing step is performed when said clock reaches said time interval; and
wherein upon determining that said user has blocked said advertisement, resetting said interval without notifying said user that said advertisement is available.

9. The method of claim 6 further comprising:
accepting user input to dispose of said advertisement.

10. The method of claim 9 wherein said user input is to view said advertisement.

11. The method of claim 9 wherein said user input is to save said advertisement.

12. The method of claim 9 wherein said user input is to delete said advertisement.

13. The method of claim 6 wherein said notification is illumination of a light on a graphical user interface.

14. The method of claim 6 wherein said notification is an email.

15. The method of claim 6 wherein said notification is a pop-up screen.

16. The method of claim 6 wherein said notification is an instant message.

17. A program product operable on a computer, said program product comprising:
a computer-usable medium;
wherein said computer usable medium comprises instructions comprising:
instructions for acquiring a user database;
instructions for defining a selection criterion;
instructions for searching said user database using said selection criterion; and
instructions for creating a list of targeted users based on said search.

18. The program product of claim 17, wherein said selection criterion is a specific user profile.

19. The program product of claim 17, wherein said selection criterion is a specific word or term in a user name.

20. The program product of claim 17, wherein said selection criterion is a specific user interest identified by the user.

21. The program product of claim 17, wherein said selection criterion is random selection of users.

22. A program product operable on a computer, said program product comprising:
a computer-usable medium;
wherein said computer usable medium comprises instructions comprising:
instructions for queuing an advertisement;
instructions for determining if a user has blocked said advertisement; and
wherein upon determination that said user has not blocked said advertisement, instructions for notifying a user that said advertisement is available.

23. The program product of claim 22 further comprising:
instructions for selecting a time interval;
instructions for starting a clock;
wherein said instructions for queuing are executed when said clock reaches said time interval; and
wherein upon determining that said user has blocked said advertisement, instructions for resetting said interval without notifying said user that said advertisement is available.

24. The program product of claim 22 further comprising: instructions for accepting user input to dispose of said advertisement.

25. The program product of claim 24 wherein said user input is to view said advertisement.

26. The program product of claim 24 wherein said user input is to save said advertisement.

27. The program product of claim 24 wherein said user input is to delete said advertisement.

28. The program product of claim 22 wherein said notification is illumination of a light on a graphical user interface.

29. The program product of claim 22 wherein said notification is an email.

30. The program product of claim 22 wherein said notification is a pop-up screen.

31. The program product of claim 22 wherein said notification is an instant message.

32. A program product operable on a computer, said program product comprising:
a computer-usable medium;
wherein said computer usable medium comprises:
a user registration program, whereby said user registration program allows a user to create a user name;
a user selection program, whereby said user registration program searches a user database for users matching a selection criterion; and
an advertisement delivery program, whereby said advertisement delivery program delivers an advertisement to said user.

33. The program product of claim 32 wherein said user registration program further allows a user to enter a user profile and at least one user interest.

34. The program product of claim 32 wherein said user selection program comprises:
instructions for acquiring a user database;
instructions for defining a selection criterion;
instructions for searching said user database using said selection criterion; and
instructions for creating a list of targeted users based on said search.

35. The program product of claim 34, wherein said selection criterion is a specific user profile.

36. The program product of claim 34, wherein said selection criterion is a specific word or term in a user name.

37. The program product of claim 34, wherein said selection criterion is a specific user interest identified by the user.

38. The program product of claim 34, wherein said selection criterion is random selection of users.

39. The program product of claim 32 wherein said user selection program comprises:
instructions for queuing an advertisement;
instructions for determining if a user has blocked said advertisement; and
wherein upon determination that said user has not blocked said advertisement, instructions for notifying a user that said advertisement is available.

40. The program product of claim 39 further comprising:
instructions for selecting a time interval;
instructions for starting a clock;
wherein said instructions for queuing are executed when said clock reaches said time interval; and
wherein upon determining that said user has blocked said advertisement, instructions for resetting said interval without notifying said user that said advertisement is available.

41. The program product of claim 39 further comprising: instructions for accepting user input to dispose of said advertisement.

42. The program product of claim 41 wherein said user input is to view said advertisement.

43. The program product of claim 41 wherein said user input is to save said advertisement.

44. The program product of claim 41 wherein said user input is to delete said advertisement.

45. The program product of claim 39 wherein said notification is illumination of a light on a graphical user interface.

46. The program product of claim 39 wherein said notification is an email.

47. The program product of claim 39 wherein said notification is a pop-up screen.

48. The program product of claim 39 wherein said notification is an instant message.

49. The method of claim 9 wherein said user input is to view additional information regarding said advertisement.

50. The method of claim 9 wherein said user input is to view a coupon associated with said advertisement.

51. The method of claim 9 wherein said user input is to run an interactive game bot.

52. The program product of claim 24 wherein said user input is to view additional information regarding said advertisement.

53. The program product of claim 24 wherein said user input is to view a coupon associated with said advertisement.

54. The program product of claim 24 wherein said user input is to run an interactive game bot.

55. The program product of claim 41 wherein said user input is to view additional information regarding said advertisement.

56. The program product of claim 41 wherein said user input is to view a coupon associated with said advertisement.

57. The program product of claim 41 wherein said user input is to run an interactive game bot.
